(19) United States
(12) Patent Application Publication
(10) Pub. No.: US 2005/0228889 A1
(43) Pub. Date: Oct. 13, 2005

(54) Adaptable in-wall network device

(75) Inventors: Michael S. Cohen, Middleton, ID (US); Justin R. Mayfield, Boise, ID (US); Jeffrey Karl Moeser, Meridian, ID (US); Jonathan C. Weech, Star, ID (US)

Correspondence Address: John R. Thompson;STOEL RIVES LLP, One Utah Center, 201 South Main Street, Suite 1100, Salt Lake City, UT, 84111, US

(73) Assignee: Dedicated Devices, Inc., Nampa, ID (US)

(21) Appl. No.: 10/898,827

(22) Filed: Jul. 26, 2004

Related U.S. Application Data
(63) Continuation-in-part of application No. 60/561,713, filed on Apr. 13, 2004.

(51) Int. Cl. G06F 15/16

(52) U.S. Cl. 709/227

(57) ABSTRACT

A network device includes a back unit that provides a network connection through a primary network interface. The back unit includes a universal mechanical and electrical connection to front units with specific hardware and/or network applications. A front unit with desired network applications is coupled to the back unit to establish a network connection to the front unit and enable the network applications. A front unit may be removed and exchanged for another front unit with different network applications as desired.

### RELATED APPLICATIONS

This application claims priority to U.S. Patent Application No. 60/561,713 entitled “Adaptable In-Wall Networked Device” filed on Apr. 13, 2004, and which is hereby incorporated by reference.

### TECHNICAL FIELD

This invention relates to computer networks, and, more specifically, to network devices that are installable throughout a building structure to provide network connectivity.

### BACKGROUND OF THE INVENTION

A computer network, such as a Local Area Network (LAN) and a Wide Area Network (WAN), provide interconnection between different computer processing nodes. The benefits of network connection have been overwhelming in the business environment. Indeed, in many corporations and firms, maintaining a network is vital to operations. Individual homeowners may also enjoy the benefits of a network installed in a residence to provide Internet access, digital media content, telecommunication, home automation control, and other services.

During construction of an office building, structured wiring for a network is often installed. An increased demand for network installation is also found in new home constructions. Although a network is desired, specific network applications for each location and each room in a building is often unknown. Network ports, nodes, and devices with specific features are not installed until a room's purpose has been determined. Furthermore, over time, a room's purpose changes based on user's needs for a room, a change in occupants or residents, and new technology.

In consideration of the foregoing, it would be an advancement in the art to provide network devices to be installed throughout a building to provide network connectivity without limitation to a specific network application. It would be a further advancement in the art to provide network devices that are adaptable to specific network applications and are easily adapted without disturbing a network connection. Such a device is disclosed and claimed herein.

### BRIEF DESCRIPTION OF THE DRAWINGS

A more particular description of the invention briefly described above will be rendered by reference to the appended drawings. Understanding that these drawings only provide information concerning typical embodiments of the invention and are not therefore to be considered limiting of its scope, the invention will be described and explained with additional specificity and detail through the use of the accompanying drawings, in which:

FIG. 1 is a block diagram of an embodiment of a network device;

FIG. 2 is a block diagram of an alternative embodiment of a network device;

FIG. 3 is a perspective view of the network device of FIG. 1;

FIGS. 4A-4D are plan views of embodiments of front units; and

FIG. 5 is a block diagram of one embodiment of a network system having one or more network devices.

### DETAILED DESCRIPTION OF PREFERRED EMBODIMENTS

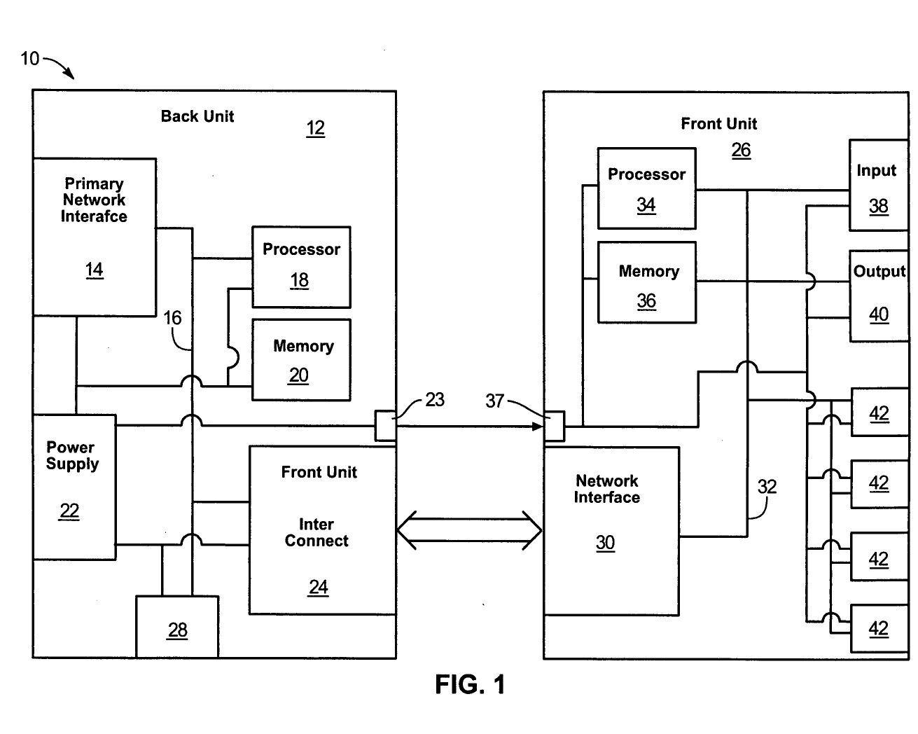

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in FIGS. 1 to 5 and is not intended to limit the scope of the invention, as claimed, but is merely representative of presently preferred embodiments of the invention.

Suitable networks for use as described here include one or more local area networks, wide area networks, metropolitan area networks, and/or “Internet” or IP networks, such as the World Wide Web, a private Internet, a secure Internet, a value-added network, a virtual private network, an extranet, or an intranet. In particular, a suitable network may be formed from parts or entireties of two or more other networks, including networks using disparate hardware and network communication technologies. One suitable network includes a server and several clients, and other suitable networks may contain other combinations of servers, clients, and/or peer-to-peer nodes, and a given computer may function both as a client and as a server.

A network may include communications or networking software, such as the software available from Novell, Microsoft, Artisoft, and other vendors, and may operate using TCP/IP, SPX, IPX, and other protocols over twisted pair, coaxial, or optical fiber cables, telephone lines, satellites, microwave relays, modulated AC power lines, physical media transfer, and/or other data transmission “wires” known to those of skill in the art. A network may encompass smaller networks and/or be connectable to other networks through a gateway or similar mechanism.

At least one of the computers is capable of using a floppy drive, tape drive, optical drive, magneto-optical drive, or other means to read a storage medium. A suitable storage medium includes a magnetic, optical, or other computer-readable storage device having a specific physical configuration. Suitable storage devices include floppy disks, hard disks, tape, CD-ROMs, DVDs, PROMs, random access memory, flash memory, and other computer system storage devices.

Suitable software to assist in implementing techniques and aspects of the invention is readily provided by those of skill in the pertinent art(s) using the teachings presented here and programming languages and tools, such as Java, Pascal, C++, C, database languages, APIs, SDKs, assembly, firmware, microcode, and/or other languages and tools. Suitable signal formats may be embodied in analog or digital form, with or without error detection and/or correction bits, packet headers, network addresses in a specific format, and/or other supporting data readily provided by those of skill in the pertinent art(s).

Referring to FIG. 1, a block diagram illustrating one embodiment of an adaptable network device 10 of the present invention is illustrated. The device 10 provides network connectivity and may be implemented in several sizes and disposed in various locations, such as at the outlet and eye levels. The device 10 may fit within standard forms used for in-wall switches, outlet boxes, and the like that are commonly used in residential and light commercial construction.

The device 10 includes a back unit 12 that provides network connectivity to a host. The back unit 12 may be installed throughout a residence or commercial building during construction where network connections are desired. The back unit 12 is a general-purpose device and is installed universally in rooms without concern for an eventual specific use. Thus, during construction, back units 12 are placed in electrical communication with a primary network, and the purpose and specific functions of a device 10 are determined at a later time.

The back unit 12 includes a primary network interface 14 to enable network connection to a primary network. The back unit 12 also includes a local bus 16 to provide local electrical communication between components. The back unit 12 further includes an inter-connect/management processor 18 to manage network traffic, identify the back unit 12 to one or more hosts, and perform other functions in accordance with the invention. The processor 18 may include a general-purpose device or may be a special purpose processing device, such as an ASIC, PAL, PLA, PLD, Field Programmable Gate Array, or other customized or programmable device.

The processor 18 is in electrical communication with a memory 20 that may include static RAM, dynamic RAM, flash memory, ROM, or other computer storage medium. The memory 20 includes data, programs, and/or instructions that are executable by the processor 18. The back unit 12 also includes a power supply 22 that is connectable to a building's power distribution wiring to provide power to the components of the back unit 12. The power supply 22 is in electrical communication with a power port 23 and with other components of the back unit 12 to provide power as required. Alternatively, a back unit 12 may receive power from a battery or from power-over network techniques. The back unit 12 further includes a front unit interconnect 24 that provides bilateral data connection to a front unit 26. The front unit interconnect 24 may provide low-bandwidth and high-bandwidth data connection.

The back unit 12 may include an output device 28, such as an LED, that provides a visual indication of network connection status. During installation, the back unit 12 receives signals from a host responsible for network management that a successful network connection exists. The processor 18 instructs the output device 28 to indicate this status. In this manner, an installer is able to confirm a successful connection. Autodiscovery protocols, such as UpnP, may be provided to facilitate connection and configuration. The installer, or host responsible for network management, assigns identification and an address to the back unit 12. The back unit communicates with a host responsible for device management and is assigned an address or other suitable designation based on its location. The initial address may be generic or may be based on the back unit's 12 location. For example, a back unit 12 may be assigned an identification or designation, such as “library.” If the room later serves as a nursery, the back unit may be so designated.

A front unit 26 is designed for specific applications and may be installed and coupled to the back unit 12 at a later time. The front unit 26 includes hardware and software to enable specific functions and features based on the intended use for a room. As such, the front unit 26 includes a particular set of resources for providing interconnect, application platform, user interface functions, gateways, sensors, etc., that make use of the back unit 12 for connection to a network. A front unit 26 may be installed or removed from a back unit 12 at any time either before or after back unit 12 is connected to a network.

The front unit 26 includes a secondary network interface 30 to enable data communication with the front unit interconnect 24 of the back unit 12. The secondary network interface 30 is in electrical communication with a bus 32 which also communicates with a processor 34 and a memory 36. The processor 34 and memory 36 may be similarly embodied as that of the back unit 12. The processor 34 enables bilateral communication with the back unit 12 to identify the front unit 26 and the hardware and software resources that the front unit 26 provides.

The front unit 26 may include a power plug 37 to couple with the power port 23 and receive power. The power plug 37 is in electrical communication with the components of the front unit 26 to provide power as needed. Although a port 23 and plug 37 are illustrated, power coupling may be achieved by any number of devices. The front unit 26 may also receive power through the secondary network interface 30 from the power supply 22 or from power-over network. The front unit 26 may also be powered by battery or by direct connection to standard structured wiring.

Optionally, the front unit 26 may include an input device 38 and an output device 40 to enable user interaction. The input device 38 may include touch pad, touch screen, sensor, or other hardware with accompanying firmware and/or software. The output device 40 may include a monitor, such as an LED, with hardware with accompanying firmware and/or software. The user interaction may confirm network connectivity, adjust operation of the front unit 26, or provide other network options.

The front unit 26 further includes one or more application devices 42 in electrical communication with the secondary network interface 30 to enable specific functions. For example, an application device 42 may be a network port to enable network connectivity with a network, a host or server, or additional computers on a network. As a network port, the application device 42 provides a connection for a network cable, such as CAT 5e (ethernet), CAT 6, coaxial, or any other conventional network cable. Data is sent and received through the secondary network interface 30 and the primary network interface 14 to support a network port.

An application device 42 may be embodied as a telephone port, such as a category 3 modular jack or other conventional connection, for telephone voice or facsimile calls. The front unit 26 may include multiple network ports or telephone ports to provide simple pass-through for telephone service and a managed switch for IP traffic. Voice or facsimile calls are sent to a server, host, or gateway where they may be transmitted through a PSTN, ISDN, or FDDI network. Voice-over IP may be employed so that analog telephony data transmitted to the network interfaces 14, 30 is then transmitted to an IP telephony gateway. The telephony gateway may be resident in a host where the telephony data is converted into a digital signal, packetized, and transmitted over the Internet.

An application device 42 may be embodied as a digital audio and/or video outlet. Audio/video signals may be stored in a digital format at a host/server and transmitted through the network interfaces 14, 30. Alternatively, the audio/video signals may be received through a host/server from exterior sources through cable, broadband, satellite, etc. A digital-enabled device connected to the application device 42 receives the digital content, such as JPEG, Windows Media, MP3, and other formats, and displays or plays the content. Thus, any room may have access to the digital content by installing a front unit 26 with an appropriate outlet on a back unit 12. A digital-enabled device includes home theater equipment, stereos, computers, monitors, and the like.

An application device 42 may be embodied as a digital media adapter to convert digital signals into a format readable by non-digital enabled devices. Stereos, televisions, and other monitors may receive converted signals and thereby have access to the digital content resident or transmitted through a host/server. A front unit 26 may provide both a straight output for digital content and a digital media adapter to enhance the scope of compatibility. Alternatively, the application device 42 may provide an analog audio/video outlet for analog signals received through the network interfaces 14, 30. The back unit 12 may couple to a host/server that transmits the analog signals from a cable or satellite feed. The use of digital media adapters allows access to digital content for non-IP enabled devices.

An application device 42 may also be embodied as a wireless portal to provide digital content for wireless distribution using wireless protocols, such as 802.11. Devices enabled for digital wireless may receive the wireless transmissions to the extent they are within the range of the wireless portal.

In addition to providing an audio/video outlet, an application device 42 may also include a local amplifier for amplifying the audio signals. The application device 42 may further include a user input/output device to allow adjustment of the local amplifier. The input/output device may be embodied as a small touch screen, keypad and LED, and the like.

An application device 42 may be embodied as a HVAC control with a user input/output device. The user input/output device allows a user to adjust a digital thermostat to effect control of a furnace and/or air conditioner. Thermostat signals may be transmitted through the back unit to a host/server which is in electrical communication with a furnace and/or conditioner. A front unit 26 with an HVAC control may be coupled to any back unit 12 throughout a building.

An application device 42 may be embodied as a security system panel with a user input/output device. A user may enable or disable a security system by entering the appropriate input including a password. A host/server in electrical communication with a security system receives the user input and operates the security system accordingly. Alternatively, the user input is transmitted directly to the security system.

An application device 42 may be embodied as an irrigation control with a user input/output device. A user may enter irrigation preferences for sprinklers located throughout the grounds. The irrigation preferences are transmitted either directly to a sprinkler system or to a host/server in electrical communication with a sprinkler system.

An application device 42 may be embodied as a weather portal to inform a user of the local weather. The application device 42 includes a small monitor to convey the current and anticipated temperature, humidity, and precipitation in the local region. The application device 42 may receive weather information signals from a host/server which receives local weather information from the Internet.

An application device 42 may be embodied as a pet boundary violation alert. A pet collar may include a GPS device or a perimeter alert device. When the pet collar travels beyond a certain radial distance from a residence or beyond a perimeter, a signal is transmitted from the collar or from a perimeter alert system to a host/server. Boundary violation information is transmitted from the host/server to the application device 42 that includes a monitor to inform a user. The monitor may display a warning to a user and include the time of the boundary violation. The application device 42 may further include a speaker to provide an audible warning of a boundary violation.

An application device 42 may be embodied as a PDA interface, such as a holster or cradle, for connecting and charging a PDA to a network. A connected PDA is addressed as another node on the network. A PDA may then download/upload digital content with a host/server, access the Internet, download email, synchronize a calendar with a personal computer on the network, and perform other conventional functions.

An application device 42 may also be embodied as a wireless port for a remote control. The remote control may be used to operate entertainment equipment, such as a television, home theater equipment, stereo and the like. User-entered signals may be transmitted from the remote control to the application device and to host/server. The host/server may then transmit signals to a device 10 with an application device 42 in electrical communication with entertainment equipment. Alternatively, a remote control may communicate directly with the entertainment equipment to select audio/video content.

An application device 42 may be embodied as a host/server interface to enable user control of the host/server. The host/server interface may include a keyboard, touch screen, mouse, monitor, and the like. Alternatively, the host/server interface may include serial and/or USB ports to enable communication with input/output devices. The host/server interface allows a user to revise, reload, and upgrade host/server software. For example, a network administrator may review system software on the host/server, access the Internet through the host/server, and download and install updated versions of system software.

An application device 42 may be embodied as a lighting control interface to enable manual and programmed control of lights. The application device 42 includes an input/output device to select a light or series of lights and operating instructions. A host/server that is in electrical communication with the AC wiring operates the lights in accordance with user input. Light control through AC wiring may use a system manufactured by Leviton Manufacturing Company, Inc. of Little Neck, N.Y., that allows for retrofit or new construction projects.

An application device 42 may be embodied as an intercom device to enable audio conversation with another application device 42 in a network. Audio signals may be transmitted over a network from one room to another. An application device 42 may be embodied as a one-way intercom, such as a microphone to monitor sounds in a room. Audio signals may be transmitted to another application device 42 that is embodied as a speaker. A microphone application device 42 may be disposed in a nursery to function as a baby monitor with the associated speaker being disposed in proximity to a caretaker.

An application device 42 may include a sensor to monitor air quality, fire, or other potential harm. Upon detection, the application device 42 informs a host/sever which immediately initiates an alarm situation. Alarms may be strategically dispersed throughout a building or may be integrated with the application device 42.

An application device 42 may include a biometric authenticator to scan a fingerprint or eye retina. After scanning, biometric information is transmitted to a host/server where the biometric information is validated against biometric information resident in memory. Authentication may be required prior to accessing the host/server, accessing a residential security system, ordering digital content, or performing other functions and features associated with a network.

One of skill in the art will appreciate that the application devices 42 discussed herein are for illustrative purposes only and are not limiting of the present invention. Application devices 42 include telephone and network connectivity, communication devices, video and audio, environmental and security control, and other devices to facilitate communication and environmental control. Front units 26 are universally accepted by back units 12 and may be changed as required. For example, if home theater equipment is moved to another room or to another place in the room, a front unit 26 may be removed and placed in proximity to the home theater equipment. A front unit 26 with a microphone application device 42 may be disposed in a nursery for monitoring an infant. If the nursery is later used as a study, the front unit 26 may be replaced with another having application devices 42 for network and telephone connectivity.

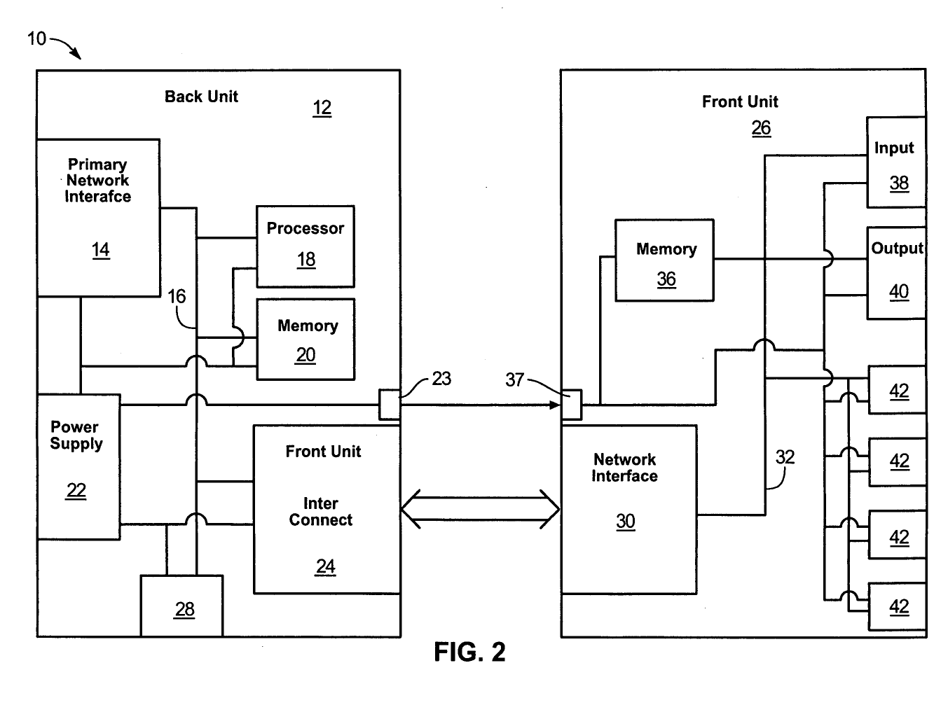

Referring to FIG. 2, a block diagram illustrating an alternative embodiment of an adaptable network device 100 is illustrated. A front unit 102 does not include a processor 34 and does not have the processing capability of the previous embodiment. The front unit 102 may include a memory 36, such as a ROM or nonvolatile memory to identify the front unit 102 and its application devices 42. Upon mechanical and electrical coupling with the back unit 12, the processor 18 accesses the memory 36 and identifies the front unit 26. Alternatively, a memory may be resident within an application device 42 to identify the hardware and/or software resource offered by the application device 42.

The front unit 102 is suited for simpler applications, such as network or telephone connectivity where processing is not required. For example, the back unit 12 identifies the front unit 102 and a network port 42. The back unit 12 includes sufficient routing capability to direct network traffic from the secondary network interface 30 to a primary network interface 14. Where a more complex application device 42 is involved, a front unit 26 may require processing capability. Furthermore, if multiple application devices 42 are used, a processor may be needed to manage network traffic.

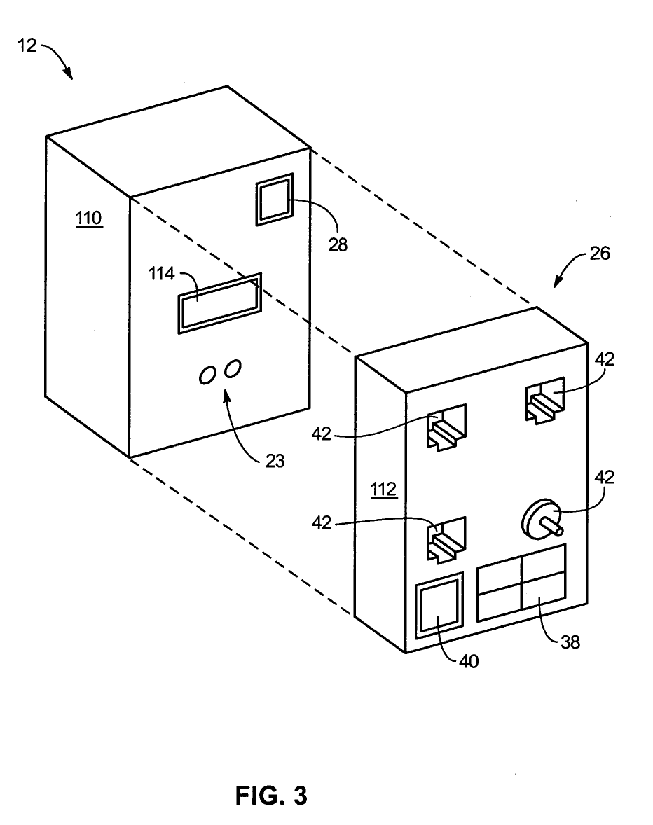

Referring to FIG. 3, a perspective view of a device 10 of FIG. 1 is shown. A back unit 12 includes a housing 110 that partially or completely encompasses the previously discussed components. An output device 28 may be disposed on or within the housing 110 to indicate a successful network connection. The housing 110 mechanically and detachably couples to a housing 112 of a front unit 26. The detachable coupling allows for the easy separation of the front unit 26 from the back unit 12 and replacement with another front unit 26. Thus, the housing 110 and housing 112 cannot be construed as an integrated component. The mechanical coupling may be enabled by any number of configurations including snap fit members, sliding interlocking members, screws and other conventional devices. The front unit 26 may be detached from the back unit 12 without disconnecting the back unit 12 from a network and without turning off power to the back unit 12. This “hot-swap” interchange facilitates the adaptability of the device 10 in converting to new applications.

The housings 110, 112 are designed to align and couple the front unit interconnect 24 and the secondary network interface 30 to enable electrical and data communication between the units 12, 26. Thus, when coupling the housings 110, 112, the front unit interconnect 24 and secondary network interface 30 are coupled as well. After coupling, the front unit interconnect 24 and the secondary network interface 30 remain detachably connected to allow for quick exchange of the front unit 26. In one embodiment, the front unit interconnect 24 may include an interconnect port 114 to receive a protruding member (not shown), such as a plug or pins, of the secondary network interface 30. The front unit interconnect 24 and secondary network interface 30 may be coupled to one another in various ways and all of which are included within the scope of the invention.

As discussed above, electrical power for the back unit 12 may be received through the power supply 22 that is in electrical communication with standard AC power distribution lines. In one embodiment, the power supply 22 is in electrical communication with the power port 23 to provide power to the front unit 26 through a power plug 37. Upon coupling the housings 110, 112, the power port 23 and power plug 37 are aligned to detachably couple to one another as well. The back unit 12 and front unit 26 may alternatively receive power by power-over network or by a battery.

The front unit 26 includes one or more application devices 42 that, in the illustrated embodiment, include network and telephone ports. The network and telephone ports 42 do not require the front unit 26 to extend far beyond a wall surface. Thus, the front unit 26 may remain relatively flush with a wall surface as is common with conventional wall outlets. The front unit 26 also includes an input 38 and an output 40 to enable user interaction with the device 10 and/or a connected network.

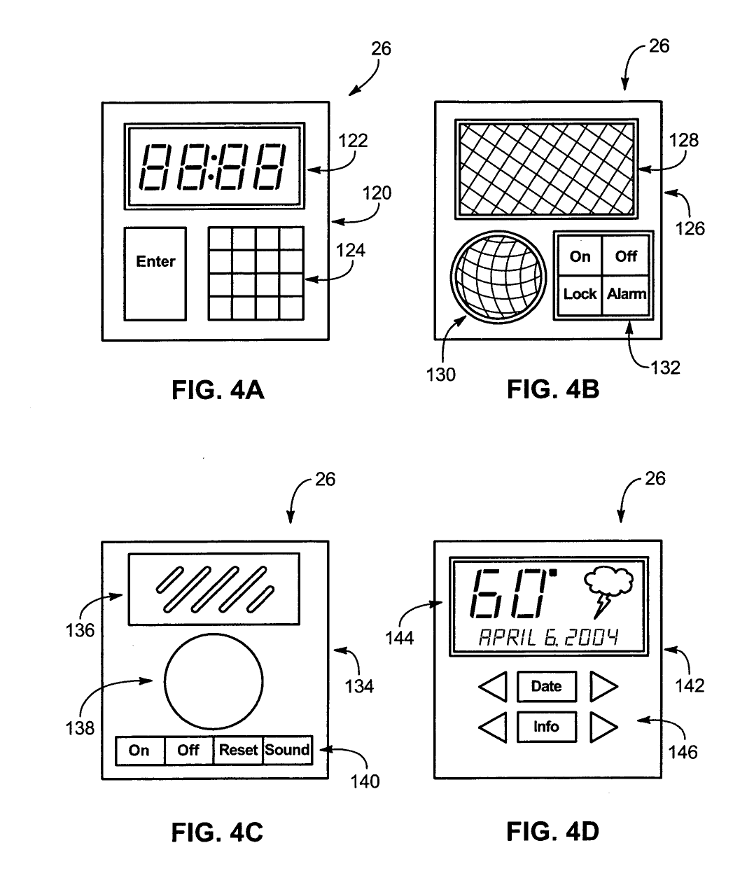

Referring to FIGS. 4A through 4D, plan views of alternative embodiments of a front unit 26 are shown with different application devices 42. FIG. 4A illustrates an application device 120 that is embodied as a control interface that may be used for a security system, HVAC, irrigation system, or a lighting system. The application device 120 includes a monitor 122 and a keypad 124 for user input. FIG. 4B illustrates an application device 126 that is embodied as an intercom interface and includes a speaker 128, a microphone 130, and a keypad 132 for operation input.

FIG. 4C illustrates an application device 134 that is embodied as a hazard sensor to detect smoke or air quality hazards. The application device 134 includes an air, smoke, or heat sensor 136, an audible and visual alarm 138, and a keypad 140 for operation input. FIG. 4D illustrates an application device 142 that is embodied as a weather portal to relay local weather information to a user. The application device 142 includes a monitor 144 to display weather information, such as temperature, date, and precipitation. The application device 142 further includes a keypad 146 to allow a user to select a day for the corresponding forecast and to select additional weather information, such as humidity, pressure, wind speed, and so forth.

The embodiments illustrated in FIGS. 4A-4D are for illustrative purposes only, and one of skill in the art would appreciate that any of the application devices 120, 126, 134, or 142 may be varied as desired. For example, a control interface may include any number of variations based on designed constraints, preferences, and additional features. A front unit 26 may also include one or more additional application devices. Thus, any of the front units 120, 126, 134, or 142 may include an additional application device, such as a network port, telephone port, or a digital media adapter.

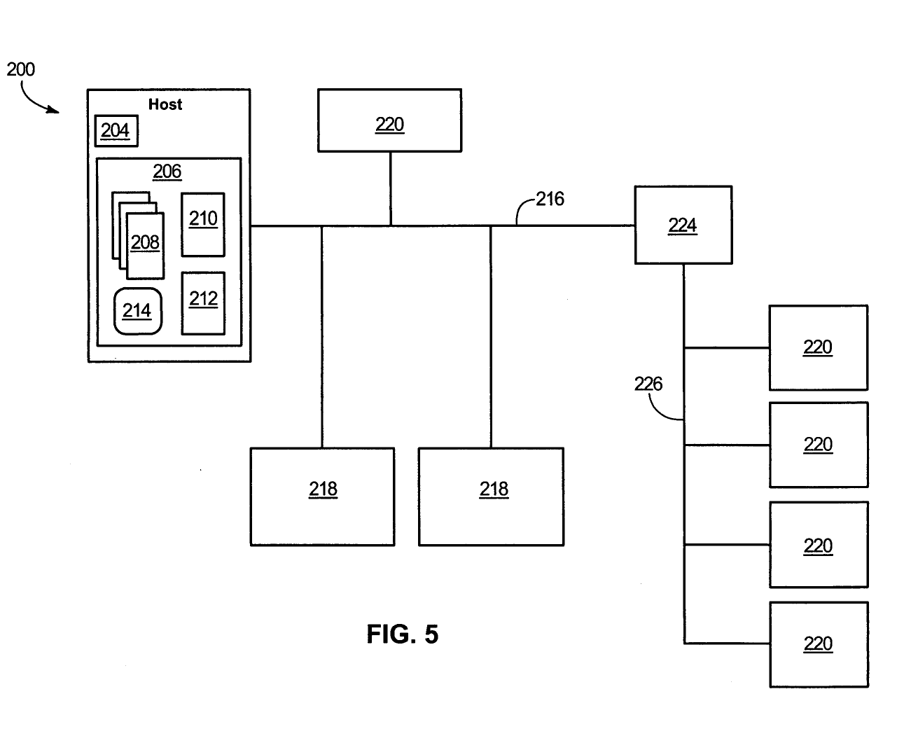

Referring to FIG. 5, a block diagram of a network system 200 that connects structured wiring with applications, such as an internal gateway, digital media server, home automation controller, and with external resources, such as telephone, cable TV, Internet, and satellite TV. The network system 200 may conform to a structured wiring panel environment with consideration of form factor, power, thermals, I/O facilities, user and installer interfaces, upgrade and maintenance strategies.

The network system 200 includes a host 202 that operates as a management node and is located at a confluence of services and distribution links. The host 202 includes a processor 204 and is in electrical communication with a memory 206 that stores software applications 208 for managing the network system 200. The host 202 includes a user interface 210 resident in the memory 206 for user control of the host 202 and other processing modules on the network system 200. The user interface 210 conveys system status and other useful information to a user. The user interface 210 is created and deployed using common tools that function across platforms and operating systems. The user interface 210 may include standard markup, reference, and display languages and tools, such as HTML, XML, abstractions of core application API's, and media/content rich tools where needed, such as Java and Flash.

The software applications 208 may be installed and accessed through the user interface 210. The functions of each software application 208 are available through the user interface 210. The user interface 210 may have a common API that allows for easy integration of new functions and applications. Software applications 208 may be delivered through separate code bases functioning independently under the user interface 210.

The host 202 includes a network gateway application 212 that is modular and customizable. The gateway application 212 may further be front-end, back-end, and database configurable and user interface agnostic. The gateway application 212 enables network management and Internet connectivity throughout a network system 200 installed within a residence or commercial building.

The host 202 may further include a database 214 for centralized storage, distribution, and access to digital content and media. In addition to network management and connectivity, the host 202 may provide automated residential control, communication, and security applications with additional modules and associated hardware.

The host 202 and the user interface 210 are in communication with a primary network structure 216 that is installed within a building to enable network connectivity with network devices 218. The network devices 218 may include computer terminals, processing nodes, sensors, controls, thermostats, light switches, health monitors, image sensors, air quality sensors, security systems, irrigation systems, HVAC, port of entry for audio/video streams, weather portal, and so forth. A network device 218 may be embodied as an adaptable in-wall network device 220 of the present invention. A network device 218 may be embodied as a user terminal 222 to allow for user interaction with the host 202. A user terminal 222 may be embodied as a general purpose computer, such as a workstation or laptop, an I/O terminal without processing capability, or other processing node.

The network system 200 may include a gateway 224 that communicates between the primary network structure 216 and a sub-network structure 226. The sub-network structure 226 is specifically implemented to provide network connectivity to one or more adaptable in-wall network devices 220 of the present invention. Alternatively, adaptable in-wall network devices 220 may communicate directly with the primary network structure 216.

In operation, the host 202 communicates with and monitors the adaptable in-wall network devices 220 and the network devices 218 and acquires and organizes state data. The host 202 may provide Internet connectivity, digital media content, telecommunications access, and a variety of other content and applications. In this manner, the host 202 distributes media content and receives feedback from the network devices 218, 220 to provide an automated and interactive network system. The network system 200 is exemplary of a network that includes adaptable in-wall network devices 220 of the present invention. As can be appreciated, adaptable in-wall network devices 220 may be used with networks of various size and configuration.

Adaptable in-wall network devices 220 provide superior network connectivity and flexibility to conventional devices. Back units 12 are universally and easily installed throughout rooms of a building without concern for the purpose of the room. Front units 26 are subsequently installed to the back units 12 to enable any number of network supported functions. Front units 26 may be replaced without disconnecting the back units 12 from a network and with little hardware installation. Rooms may be refitted with front units 26 to provide new and enhanced features as desired.

It will be obvious to those having skill in the art that many changes may be made to the details of the above-described embodiments without departing from the underlying principles of the invention. The scope of the present invention should, therefore, be determined only by the following claims.

1. A network device for placement in a wall surface and establishing network connectivity with a network, comprising:
a back unit, including,
a back unit housing,
a processor disposed within the back unit housing,
a memory disposed within the back unit housing and in electrical communication with the processor and including executable applications for managing network communication,
a primary network interface in electrical communication with the processor to communicate electronically with a network, and
a front unit interconnect in electrical communication with the primary network interface; and
a front unit, including,
a front unit housing to mechanically and detachably couple to the back unit housing,
a secondary network interface to couple to and electrically communicate with the front unit interconnect upon coupling the front unit housing to the back unit housing, and
an application device in electrical communication with the secondary network interface and, upon coupling of the secondary network interface to the front unit interconnect, in electrical communication with the primary network interface.

2. The network device of claim 1, wherein the back unit further includes a power supply in electrical communication with the processor, memory, primary network interface, and front unit interconnect to provide power.

3. The network device of claim 2, wherein the back unit further includes a power port in electrical communication with the power supply and the front unit further includes a power plug in electrical communication with the secondary network interface and the application device, the power plug to couple to and electrically communicate with the power port upon coupling the front unit housing to the back unit housing.

4. The network device of claim 1, wherein the back unit further includes an output device in electrical communication with the primary network interface to display a status of a network connection.

5. The network device of claim 1, wherein the front unit further includes a processor disposed within the front unit housing and in electrical communication with the secondary network interface.

6. The network device of claim 5, wherein the front unit further includes a memory disposed within the front unit housing and in electrical communication with the secondary network interface and including executable applications for managing network communication.

7. The network device of claim 1, wherein the front unit further includes an input device and an output device to enable user interaction.

8. The network device of claim 1, wherein the application device includes a network port to enable network connectivity with an external device.

9. The network device of claim 1, wherein the application device includes a telephone port to enable voice and facsimile communication with an external device.

10. The network device of claim 1, wherein the application device includes a network port to enable network connectivity with an external device and wherein the front unit further includes a second application device that includes a telephone port to enable voice and facsimile communication with an external device.

11. The network device of claim 1, wherein the application device includes a digital media adapter to provide digital media content to an external device.

12. The network device of claim 1, wherein the application device includes a control interface having an output device to display content to a user, and an input device to receive user commands, wherein the control interface prompts for and receives the user commands to effect operation of an external system.

13. The network device of claim 1, wherein the application device includes a communication system having a speaker, a microphone, and an input device to receive user commands.

14. The network device of claim 1, wherein the application device includes a sensor to detect a hazard and an alarm.

15. The network device of claim 1, wherein the application device includes an output device to display weather information and an input device to receive user commands.

16. The network device of claim 1, wherein the application device includes a PDA port to interface with an external PDA.

17. The network device of claim 1, wherein the application device includes an input device and an output device to enable user interaction with a network to be in electrical communication with the primary network interface.

18. A network device for placement in a wall surface and establishing network connectivity to a network, comprising:
a back unit, including,
a back unit housing to mechanically and detachably couple to a front unit housing,
a processor disposed within the back unit housing,
a memory disposed within the back unit housing and in electrical communication with the processor and including executable applications for managing network communication,
a primary network interface in electrical communication with the processor to communicate electronically with a network, and
a front unit interconnect in electrical communication with the primary network interface and to couple to and electrically communicate with a secondary network interface of a front unit upon coupling the back unit housing to a front unit housing.

19. The network device of claim 18, wherein the back unit further includes a power supply in electrical communication with the processor, memory, primary network interface, and front unit interconnect to provide power.

20. The network device of claim 19, wherein the back unit further includes a power port in electrical communication with the power supply and the power port to couple to and electrically communicate with a power port of a front unit upon coupling the back unit housing to a front unit housing.

21. The network device of claim 18, wherein the back unit further includes an output device in electrical communication with the primary network interface to display a status of a network connection.

22. A network device for placement in a wall surface and establishing network connectivity to a network, comprising:
a front unit, including,
a front unit housing to mechanically and detachably couple to a back unit housing,
a secondary network interface to couple to and electrically communicate with a front unit interconnect of a back unit upon coupling the front unit housing to a back unit housing, and
an application device in electrical communication with the secondary network interface and, upon coupling of the secondary network interface to a front unit interconnect of a back unit, in electrical communication with a primary network interface of a back unit.

23. The network device of claim 22, wherein the front unit further includes a power plug in electrical communication with the secondary network interface and the application device, the power plug to couple to and electrically communicate with a power port of a back unit upon coupling the front unit housing to a back unit housing.

24. The network device of claim 22, wherein the front unit further includes a processor disposed within the front unit housing and in electrical communication with the secondary network interface.

25. The network device of claim 24, wherein the front unit further includes a memory disposed within the front unit housing and in electrical communication with the secondary network interface and including executable applications for managing network communication.

26. The network device of claim 22, wherein the front unit further includes an input device and an output device to enable user interaction.

27. The network device of claim 22, wherein the application device includes a network port to enable network connectivity with an external device.

28. The network device of claim 22, wherein the application device includes a telephone port to enable voice and facsimile communication with an external device.

29. The network device of claim 22, wherein the application device includes a network port to enable network connectivity with an external device and wherein the front unit further includes a second application device that includes a telephone port to enable voice and facsimile communication with an external device.

30. The network device of claim 22, wherein the application device includes a digital media adapter to provide digital media content to an external device.

32. The network device of claim 22, wherein the application device includes a control interface having an output device to display content to a user, and an input device to receive user commands, wherein the control interface prompts for and receives the user commands to effect operation of an external system.

33. The network device of claim 22, wherein the application device includes a communication system having a speaker, a microphone, and an input device to receive user commands.

34. The network device of claim 22, wherein the application device includes a sensor to detect a hazard and an alarm.

35. The network device of claim 22, wherein the application device includes an output device to display weather information and an input device to receive user commands.

36. The network device of claim 22, wherein the application device includes a PDA port to interface with an external PDA.

37. The network device of claim 22, wherein the application device includes an input device and an output device to enable user interaction with a network.

38. A network device for placement in a wall surface and establishing network connectivity to a network, comprising:
a back unit, including,
a back unit housing,
a back unit processor disposed within the back unit housing,
a back unit memory disposed within the back unit housing and in electrical communication with the back unit processor and including executable applications for managing network communication,
a primary network interface in electrical communication with the processor to communicate electronically with a network, and
a front unit interconnect in electrical communication with the primary network interface; and
a front unit, including,
a front unit housing to couple to the back unit housing,
a front unit processor disposed within the front unit housing,
a front unit memory disposed within the front unit housing and in electrical communication with the front unit processor and including executable applications for managing network communication,
a secondary network interface to couple to and electrically communicate with the front unit interconnect, and
an application device in electrical communication with the secondary network interface and to electrically communicate with the primary network interface.

39. The network device of claim 38, wherein the back unit further includes a power supply in electrical communication with the back unit processor, back unit memory, primary network interface, and front unit interconnect to provide power.

40. The network device of claim 39, wherein the back unit further includes a power port in electrical communication with the power supply and the front unit further includes a power plug in electrical communication with the front unit processor, front unit memory, secondary network interface and the application device, the power plug to couple to the power port.

41. The network device of claim 38, wherein the application device includes a network port to enable network connectivity with an external device.

42. The network device of claim 38, wherein the application device includes a telephone port to enable voice and facsimile communication with an external device.

43. The network device of claim 38, wherein the application device includes a digital media adapter to provide digital media content to an external device.

44. The network device of claim 38, wherein the application device includes a control interface having an output device to display content to a user, and an input device to receive user commands, wherein the control interface prompts for and receives the user commands to effect operation of an external system.

45. The network device of claim 38, wherein the application device includes a communication system having a speaker, a microphone, and an input device to receive user commands.

46. The network device of claim 38, wherein the application device includes a sensor to detect a hazard and an alarm.

47. The network device of claim 38, wherein the application device includes an input device and an output device to enable user interaction with a network to be in electrical communication with the primary network interface.

48. A method for providing network connectivity, comprising:
providing power to a back unit, the back unit including,
a back unit processor,
a back unit memory in electrical communication with the back unit processor,
a primary network interface in electrical communication with the processor, and
a front unit interconnect in electrical communication with the primary network interface;
establishing a connection between the primary network interface and a network;
assigning an address to the back unit;
after establishing a connection, coupling a front unit to the back unit, the front unit including,
a secondary network interface, and
an application device in electrical communication with the secondary network interface; and
upon coupling the front unit to the back unit, coupling the secondary network interface of the front unit to the front unit interconnect to thereby provide network connectivity to the application device.

49. The method of claim 48, wherein the back unit further includes a back unit housing and the front unit further includes a front unit housing, and wherein coupling the front unit to the back unit includes mechanically and detachably coupling the back unit housing to the front unit housing.

50. The method of claim 48, wherein the back unit further includes a power supply and a power port in electrical communication with the power supply, and the front unit further includes a power plug, and wherein coupling the front unit to the back unit includes detachably and electrically coupling the power port and the power plug.

51. The method of claim 48, further comprising:
removing the front unit from the back unit while maintaining a connection between the primary network interface and a network;
removing the secondary network interface from the front unit interconnect; and
coupling a second front unit to the back unit.
